(19) United States
(12) Patent Application Publication
(10) Pub. No.: US 2019/0002698 A1
(43) Pub. Date: Jan. 3, 2019

(54) Product with absorbed gel

(71) Applicant: Enrico Maria Rossi, Vigonza (PD) (IT)

(72) Inventor: Enrico Maria Rossi, Vigonza (PD) (IT)

(73) Assignee: NX GEL LLC, Henderson, NV (US)

(21) Appl. No.: 16/125,669

(22) Filed: Sep. 8, 2018

Related U.S. Application Data
(63) Continuation-in-part of application No. 13/582,743, filed on Sep. 4, 2012, now abandoned.

(30) Foreign Application Priority Data
Mar. 3, 2010 (IT) PD2010A000062

(51) Int. Cl. C08L 91/00; C08J 5/18; C08J 9/42; C08J 5/24; C09K 5/06; B32B 37/15; B32B 25/10; B32B 25/04; B32B 25/02

(52) U.S. Cl. CPC C08L 91/00; B32B 2264/0257; C08J 9/42; C08J 5/24; C09K 5/06; B32B 37/153; B32B 25/10; B32B 25/042; B32B 25/02; C08L 2201/08; C08L 2205/025; C08L 2205/035; C08L 2207/04; C08L 2207/066; C08J 2391/00; C08J 2425/16; C08J 2423/06; C08J 2491/06; C08J 5/18

(57) ABSTRACT

A product with absorbed gel leaving the exposed surface of such product free of stickiness and/or free of the release of oils in any appreciable amounts.

### FIELD OF THE INVENTION

The field of this invention concerns a method for the direct joining and/or combining of a gel with a substrate of compatible material and relative product obtained. It is necessary to apply a layer of gel, especially of a very soft gel, on a suitable support when it is not possible, for reasons of cost and for structural reasons, to manufacture an entire product with gel only.

### BACKGROUND OF THE INVENTION

Currently, therefore, to apply a layer of soft reticulated, polyurethane or silicone gel, at various thicknesses, on any type of substrate it is necessary to enclose it inside a bag to prevent it dispersing. Nevertheless there is always the risk that this bag could break accidentally, following some abrasion, with the inconvenience of the gel contained in the bag spilling out.

Since, moreover, the shapes of the required products, and in particular of the bags containing said gel, have to satisfy the conditions of use of such products, and above all the bags, they have special spatial forms. In order to be able to confer three-dimensional geometric shapes to said bags, costly and complicated vacuum injection systems are necessary.

When one needs to provide certain properties, like the specific properties of a gel, to a support, it is necessary to use a coupling procedure. Indeed, to apply a layer of thermoplastic polymeric gel to a substrate it is necessary to first of all create a panel or a sheet made totally of polymeric gel, then join it to a foamed or fibrous support and then lastly glue said gel with the fibrous support to the substrate.

Nevertheless this procedure has some limitations, i.e. the limits of hardness due to the increasing stickiness of the gels diminishing the hardness.

If one must use a gel that needs to be confined in a bag there is a serious limitation of the breathability of the surfaces; in fact in the case of the bag there is the impossibility of perforating it after it has been applied.

While in the eventuality of being able to use a gel sheet, to allow the surfaces of the product to breathe it is necessary to provide a certain number of holes, with a dimension and position that is decided a priori; before the mold is made.

It seems clear, therefore, that there is a difficulty in obtaining products, also in small runs or with a limited number of pieces, since it is necessary to vary the surface forms and the positioning of any holes, according to the application, related to the necessary passage through a mold.

In addition to what has been set out earlier, currently the joining of a substrate and a layer of gel takes place with special methods of gluing onto the substrate of a fabric or the like fixed to the accessible surface of a layer of gel when it is still in its molten state.

This is obviously possible only for surfaces of particularly simple gels and as a result the application on corresponding surfaces of the substrate on which it is to be applied.

When the configuration of the substrate has marked contours, hollows, curves, angularity and the like, what has been set out above is no longer feasible.

Moreover, the gel products currently available on the market have a limited lifetime because the physical and mechanical characteristics of the gel degrade over time.

The gel viscosity of the gel is generally adjusted in real time during the process for promoting a good chemical adhesion between the gel substrate and the porous substrate.

The gel composition may vary as a function of the desired viscosity whereas the viscosity of the gel vary as a function of the kind of the porous substrate.

Moreover, the mechanical features of the gel vary as a function of its viscosity.

Therefore, a drawback of this effect is that a same kind of article made with different porous substrate (i.e. fabric layer and elastomeric layer) comprises gel with different viscosity and mechanical features.

In order words, the mechanical features of the gel vary as a function of its viscosity and this drawback may influence the use and the lifetime of the product.

The purpose of this patent is to overcome the limitations of the well-known technology set out above and those that seem better below in this description.

### SUMMARY OF THE INVENTION

A product with absorbed gel, comprising a porous substrate, a gel substrate comprising a polymer compound, and a paraffinic aromatic oil and a viscosity modifiers compound; wherein the viscosity modifiers compound comprises: a) a powder of low density ultrafine polyethylene, b) a slip agent and c) a linear low density polyethylene resin.

### DETAILED DESCRIPTION OF EMBODIMENTS OF THE INVENTION

The present invention concerns a product made of a material compatible with a gel and directly joined and/or united with a gel, with the advantage of being non-sticky to the touch and/or of not releasing any residual oil.

In particular, the product comprises an elastomeric porous substrate and a gel substrate having a polymer compound, a paraffinic aromatic oil and a viscosity modifiers compound which comprises a powder of low density ultrafine polyethylene, a slip agent and a linear low density polyethylene resin.

The polymer compound may comprising a thermoplastic elastomer such as SEBS, SBS, SIS, EVA, SEPS, SPBS polymer or their mixture, with parts by weight between 5% and 50%, and includes a paraffinic or aromatic oil with parts be weight up to 95%. So the product can be used directly without any top film to protect the gel, also in the event that the gel is exposed at a thickness beyond the base of the product and not completely absorbed into the substrate of the product.

The viscosity modifiers compound used in the gel comprises a powder of low density ultrafine polyethylene, a slip agent and a linear low density polyethylene resin.

The main advantage of this composition of viscosity modifiers compound is that the viscosity of the gel can be vary without obtain a negative reduction of the hardness, flexibility and straight thereof.

The particular viscosity modifiers compound used in this invention allow to adjust the viscosity of the gel in order to: a) maximize absorption thereof into the cavities of the elastomeric porous substrate b) maintain substantially constant the mechanical features of the gel.

Moreover, the above-mentioned viscosity modifiers compound allows to increase the overall plasticity of the gel in order to improve its workability of the molten product.

The above-mentioned gel that provides for the above mentioned characteristics, with products diffused with gel in the substrate of the product, has a number of properties, some of which are:

variable hardness;

no residual stickiness;

very low viscosity of the molten material, in all its degrees of hardness, in order to favor its absorption into the substrate;

no release of oils, or in some cases only negligible;

high degree of transparency

better mechanical characteristics than those of gels normally used in similar products;

The formulation of said gel has a hardness that ranges from 5 Sh00 to 10 ShA, in any event an even greater hardness is possible.

This gel is the result of a mixture of a viscosity modifiers compound, at least two SEBS polymers (or other polymers mentioned above) with differing molecular weights and a paraffinic or aromatic oil, and preferably white and of a medical grade (like white Marcol and Primol oils).

The viscosity modifiers compound comprises a powder of low density ultrafine polyethylene, a slip agent and a linear low density polyethylene resin.

The particles of the powder of low density ultrafine polyethylene may have a substantially spherical shape and an average size comprised between 10 micron and 50 micron.

Moreover, the powder of low density ultrafine polyethylene may be comprised between 1% and 7% by weight of the overall article.

A ultrafine polyethylene powder is adapted to be dispersed into the viscosity modifiers compound and it is used in order to obtain a smooth and bright outer surface of the gel substrate.

The powder of low density ultrafine polyethylene prevents the development of porosity at the outer surface of the gel and decrease the viscosity of the molten gel.

The powder of low density ultrafine polyethylene has the same softening temperature and elongation at break of the gel substrate and it is used even to make the gel substrate substantially waterproof to the air and fluids substance.

Moreover, the powder of low density ultrafine polyethylene is resistant to atmospheric and chemical agents and it is no dangerous for the humans because this powder is already used to make product designed that come into contact with food or beverages.

The slip agent may comprise a refined vegetable oil mixed with erucamide. This agent is used to reduce friction between the polymer and processing equipment and also between the polymer-polymer interfaces.

The slip agent migrates on the outer surface of the gel in order to provide a slip and anti-friction effect between the gel and the porous substrate designed to come in reciprocally contact.

Another effect of the slip agent is that of decrease the viscosity of the gel in order to allow the uniform spreading of the gel on the porous substrate.

The slip agent may comprised between 0.25 and 1.6% by weight of the overall product.

Preferably, the linear low density polyethylene resin may comprises hexane copolymer and may be comprised between 0.5% and 2% by weight of the overall product.

In particular, this resin increase the workability of the melted gel and decrease the retirement the gel upon its cooling in such a manner to minimize the surface tension at the outer surface of the gel in direct contact with the porous substrate.

Moreover, the linear low density polyethylene resin allows to decrease the viscosity of the gel, in particular at the outer surface thereof.

The gel substrate may further comprise an antioxidant, preferably selected into the group of the phenolic antioxidant.

In particular, the antioxidant may be comprised between 01% and 0.5% by weight of the overall product.

The use of the antioxidant a) avoids that the polymers characteristics degrade during the heating of the gel and b) increase the chemical stability of the same to the atmospheric agents.

The gel substrate may comprises a phase change material adapted to store and release energy by undergoing a phase change its liquid and solid states.

Preferably, the phase change material may be comprised up to 25% by weight of the overall product and may comprise particles containing paraffin.

The melting point of the particles may be comprise between 24° C. and 32° C. and preferably close to 28° C. in order to generate the heating of the gel when the product is in contact with the human body.

The SEBS polymers are present in percentages of 5 to 39.5%. Mixing the polymers with different molecular weights provides surprising characteristics:

the adjustment of the viscosity of the molten liquid in order to favor absorption. For each degree of hardness it is, in fact, possible to find the best composition that provides a molten gel with lower viscosity. As will be explained in the description below, this characteristic is important for obtaining a low viscosity of the molten product that allows the gel to be absorbed in the holes of the porous substrate and prevents them being plugged up.

the variation of the mechanical characteristics of the gel to obtain gels that do not need films (i.e. with a barrier layer on the surface in order to overcome the drawbacks of stickiness and the release of residual oil) and with excellent mechanical characteristics. In particular it is possible to eliminate the residual stickiness and prevent abrupt phenomena of wear and tear due to rubbing. Moreover the gel substrate present a substantially constant mechanical features that do not vary as a function of the viscosity.

the elimination of the release of oils by the gel or to limit it to practically negligible levels. The benefit of using white medical grade oil is that any small releases are not harmful since the only thing that is released is said white medical grade oil, which is harmless if it comes into contact with skin.

increasing the amount of polymers in the gel without any considerable increases in the hardness and viscosity of the molten product.

In the formulation of said gel it has been seen that in order to prevent releases of oil and to reduce stickiness it is necessary to increase the content of SEBS polymers in the gel. However, the increase in the amount of polymers means substantially increasing the viscosity (in contrast to the low viscosity needed to facilitate absorption into the substrate and to obtain hollow and unblocked ventilation holes in the substrate). This goal has been realized with the adoption of SEBS polymers with different molecular weights. Polymers with a lower molecular weight provide very low viscosity. In particular, the percentage of the high molecular weight polymers may be comprised between 5% and 14.5% by weight and the percentage of the low molecular weight polymers may be comprised between 5% and 25% On the other hand they have slightly inferior mechanical properties to rubbers with a high molecular weight.

Polymers with a low molecular weight also have a lesser capacity for retaining oils.

Therefore, in order to obtain the product of this invention, oils with a suitable viscosity were used; in fact the viscosity of the white oils used has an influence on the release of these very oils by the gel. In particular, the higher their viscosity (measurement method ASTM D445) the more limited is their release by the gel. On the other hand, with oil that has high viscosity there is a sizeable increase in the viscosity of the molten product. The best results in terms of the workability of the molten product and the release of oils by the gel were obtained with white oils with a viscosity between 30 and 100 cSt at a temperature of 40° C. (ASTMD445). The use of high viscosity oils also influences the softening temperature of the gel; in particular oils with a higher viscosity increase them considerably.

Another object of the invention concerns a method for the direct joining and or coupling of a gel with a substrate of porous material. This method and/or bonding is configured as an absorption and/or diffusion and/or union and/or surface deposition of a film of polymeric gel, with the benefit of a hardness that varies between 5 SH00 and about 10 SHA, to any compatible substrate, with any surface form and with a variable thickness.

This method and/or bonding is a joining of a compatible porous substrate, like natural fabric or elastomeric substrate like polyurethane foam, viscoelastic polyurethane, latex, sponge, fabrics, and any porous material that can absorb and/or bind with SEBS, SBS, SIS, EVA, SEPS, SPBS polymer based gel or their mixture by means of extrusion. This coupling, due to the absorption and/or surface deposition of said gel onto a base, or compatible substrate, considerably modifies the characteristics of the product before and after the treatment according to parameters like: hardness of the absorbed and/or molded gel, depth of penetration, density of the substrate and morphology of the open cells for the foams.

This joining, therefore, is better than a simple gluing of the gel onto the product, since it takes place through absorption with a consequent mechanical seal over the entire contact surface between the two phases, therefore avoiding the need for successive gluing after obtaining the product, as in the case of polymeric gel panels.

An important property of the final product is obtained by controlling the absorption: in fact it is possible to have the gel be fully absorbed into the product and avoid having to cover it with a film or other products to prevent its stickiness and quick degradation due to abrasion. Therefore with the above-mentioned method it is possible and very useful to make small production runs and solutions with multiple structures and forms.

An important benefit consists of the fact that the joined material can be shaped before or after the deposition and/or absorption of the gel in order to increase its breathability.

Another big advantage is that with a final application of a small layer of very hard polymer one can completely eliminate the residual stickiness and possible sudden tear action due to the high degree of abrasion, as well as possible release of plasticizers and/or oils. Naturally the above-mentioned products that are obtained can be of any dimension since it is sufficient to modify the dimension of the mixer, fuser or extrusion head to obtain as a result the product obtained.

Advantageously the products obtained with the above-mentioned method and/or union with the coating system have no limits regarding size.

Other numerous advantages obtained with the above-mentioned method and/or union are set out below.

### Product Perforation

One important benefit of the above-mentioned product is the possibility of putting holes in the product before or after the coating/absorption with the gel without the danger that, in the event that bags containing gel are used, the gel comes out of the bags, if they are bored after they have been applied, and to put holes in said product in the desired positions through the more common methods of putting holes in fabric, foam or rubber products. The application of this soft gel coating and/or absorption of the gel enables putting holes in the above-mentioned products, before or after the application of the gel, thereby considerably increasing the breathability of the final product, something that is not possible with the insertion of bags containing gel. The making of the holes can be done in various ways on the basis of requirements and can be carried out with all the usual methods for making holes.

There was success, moreover, in keeping the holes of the substrate open by acting on the viscosity of the gel, preventing them from getting blocked, eventually applying a depressurization near the deposition so that the gel penetrates into the holes and is absorbed leaving the hole free. Applying a depressurization also in the post-deposition zone favors the functional capacity of the holes.

Obviously the degree of the depressurization has to be adjustable since:

the height of the substrate where the gel is deposited;

the viscosity of the gel;

the temperature of the substrate;

the treatment speed;

the dimension of the holes:

all effect the effectiveness of the holes.

The alternative to this, in the event that the holes are for any reason blocked, is the cutting of the piece once the gel has been deposited, something that is possible because the gel is not sticky and does not release residual oils, not only on the surface but also in the material diffused in the substrate of the product.

### Non-Stickiness of the Outer Layer of Gel

Also considered is the eventual use of a gel with a hardness that is lower than those set out above and that maintains a residual stickiness.

It is possible that after the above-mentioned method the product that is directly obtained has some residual stickiness, due in particular to the very low degree of hardness of the gel employed. This drawback is overcome, completely eliminating the stickiness at the end of the process, with a layer of varnish, or with a compatible polymer with a high degree of hardness (preferably greater than 5 ShA).

For instance, the linear low density polyethylene resin allows to reduce the stickiness of the outer layer of gel.

The application of a final layer of compatible non-sticky coating (or polymer) provides for a considerable reduction of wear and tear due to excessive friction, also the complete absorption of the gel into the substrate eliminates the possibility of the degradation of the gel due to wear.

### Application of Gel Layer on the Substrate without Intermediate Bonding

The object of the invention set out in this patent provides for the direct application of the layer of gel onto the suitable substrate without having to make use of intermediate gluing or gluing after the product has been produced.

The regulation of the thickness of the layer of gel based on the number of immersions and/or speed of extraction and/or viscosity of the gel.

The thickness of the gel can be continually varied without having to make special molds or equipment. By varying the speed of the extraction, the number of passes of the coating or extrusions, it is possible to put down more layers until the desired thickness of the gel is absorbed and/or deposited.

### Low Costs for Coating Compatible Substrates

The above-mentioned object of the patent provides for a rapid, quick and inexpensive method for coating compatible substrates. No particular molds or costly production lines are needed.

The surprising effect of the combination of the characteristics of the product obtained and a decrease in degradation.

The special soft gel covering provides for increasing comfort and thermal properties of the substrates on which it is applied. In the case of polyurethanes there is an increase in the lift.

### Control Over Depth of Absorption

With the above-mentioned object of the patent that provides for regulating the degree of penetration of the gel into the substrate substantially altering the surface properties, i.e. there will be three layers with different characteristics from each other with regards to their mechanical behavior. By varying the thicknesses of each layer it is possible to create a myriad of products all with different characteristics for all requirements.

### Variance of Surface Forms of the Obtained Product

With the above-mentioned object of the patent it is possible to apply without distinction a layer of gel, with varying degrees of thickness, to a substrate with any type of structure and shape. There is no need for counter-molds or molds since the form of the surface, once the product has been absorbed and/or applied, is that of the substrate.

### Variance of Deposits and Behaviors with Depositions of Products Having Different Properties

With the above-mentioned object of the patent it is possible to carry out several depositions and/or absorptions of materials with different properties, both regarding color and mechanics, in order to obtain products with the most diverse properties according to the various requirements, regarding the furniture industry, vehicles, bedding, padding, including medical and orthopedic applications, and with the realization of special aggregates or items that have been covered in or absorbed soft gel with excellent pressure relief, anti-bedsore and comfort properties.

To obtain one or more of these beneficial characteristics, the above-mentioned method and/or coupling, which is the object of the patent, can be carried out in various ways, all falling within a single inventive principle, but realized with the following techniques, set out by way of example only and not meant to be in any way restrictive.

### Extrusion Method

To carry out the deposition using the extrusion method one can use a standard extruder for polyolefins fitted with a head that is suitable for depositing the film. This method comprises a following steps: a) providing the gel substrate, b) providing a porous substrate (i.e. a natural fabric substrate or an elastomeric substrate), c) loading the gel substrate into an extruder with a head adapted to laying down a film of the gel substrate, d) regulating the temperature of the extrusion, e) adjusting the viscosity of the gel substrate by varying the mixture of the polymer compound and the amount of the viscosity modifiers, f) extruding the gel substrate onto the porous substrate in order to obtain extruded products having the gel substrate overlapping on the porous substrate.

Preferably, step e) is carried out with a combination of two different steps: varying the percentage of the high and low molecular weight polymers in the polymers compound, and varying the respective percentage of the powder of low density ultrafine polyethylene, and of the slip agent and of the linear low density polyethylene resin in the viscosity modifiers compound.

In step f) the porous substrate may be moved along a movement liner axis with a predetermined speed (i.e., the porous substrate may be place on al conveyor belt or a similar movement device).

In step f) the extrusion speed of the gel may be vary as a function of the linear movement speed of the porous substrate.

A good and uniform adhesion of the gel on the porous substrate is obtained when viscosity of the gel relative low.

Therefore, when the viscosity of the gel is relative low, it is possible to obtain layers of the gel with a high thickness even using, respectively, high extrusion speed and high movement speed of the porous substrate.

The method may comprises an eventually step g) of repeating the extrusion step f) to obtain a required gel thickness.

It is important to note that during step f) a further step h) is carried out. In particular, in the step h) a vacuum is applied at the area comprising the extrusion head in order to promote the absorption of the gel by the substrate.

In step h) the dimension of pores of the porous substrate increase and this effect improve the absorption of the gel into the structure of the porous substrate.

The absorption is superficial effect wherein the outer surface of the gel and the outer surface of the porous substrate are reciprocally joined with a weak chemical bound,

Step h) provides an improvement of the bond between the gel and the porous substrate and reduce the time of the coupling of these materials.

Moreover, it is possible to control the viscosity of the gel and the absorption and thickness of the deposition by adjusting the extrusion temperatures and the temperatures of the substrate.

A film of gel is applied on the substrate of compatible material, with the requisite speed of movement of the delivery, delivery pressure and amount of product delivered.

Once the absorption and/or deposition have been carried out, the piece is put in a place that is used for cooling.

It is possible to carry out the process more than once (over the entire piece or just in parts of it) in order to reach the desired thickness. It is possible to repeat the process on one or more pieces to obtain different properties for the product obtained.

### Additional Methods

### Immersion Method

The devices used are a mixer or a fuser, preferably fitted with a high capacity turbine, three-paddle or helix mixer, splined onto a variable speed motor or else on a motor fitted with an inverter.

The gel is melted and the thermostating is maintained, and at this point the mass of the product is ready for coating through immersion.

A chemically compatible or sufficiently porous substrate is immersed into the molten liquid up to the desired level and kept for the time needed for the chemical and/or chemical fixing and the attainment of the required absorbed thickness. Once the fixing time is finished one can start extracting the piece from the molten liquid at a constant rate. The piece can be immersed either manually or automatically.

Once the piece has been extracted it is put in a place that is used for cooling.

It is possible to carry out the process more than once in order to reach the desired thickness. It is possible to repeat the process on one or more pieces to obtain different properties for the product obtained.

### Hot Coating Method

The mixer is directly connected to a hot delivery unit that can directly spray the molten product. The delivery unit is normally composed of a pump that can operate at high temperatures, tubes for carrying heated materials and a spray-gun with a hot or cold nozzle.

The film is applied to the substrate using standard coating methods (with usual movement speeds of the spray-gun, delivery pressure and amount of product sprayed).

Once the absorption and/or deposition have been carried out, the piece is put in a place that is used for cooling.

It is possible to carry out the process more than once (over the entire piece or just in parts of it) in order to reach the desired thickness.

It is possible to repeat the process on one or more pieces to obtain different properties for the product obtained.

### Solvent-Based Coating Method

As far as the attainment of the film using solvent-based spraying is concerned, or else using flow coating technology or airless coating, it is necessary to solubilize the SEBS, SBS, SIS, EVA, SEPS, SPBS material or gel that is to be deposited to create a coating. Solvents like: xylene, methylethylchetone, toluene, benzene, hexane, cyclohexane and polar solvents are the most suitable.

The material can be solubilized, while continually agitated, until the desired viscosity is reached for the application with percentages in weight between 5% and 30% depending on the composition; The viscosity of the applied product directly influences the thickness that can be attained in a single application and the degree of penetration into the substrate, if this is absorbent with regard to the coating previously obtained.

The application can be carried out using any spray technology, since all viscosities can be reached by increasing or lowering the concentration of the gel or molten polymer.

The film is applied to the substrate using standard coating technologies.

Once the absorption and/or deposition have been carried out the piece is put in a place that is used for the stripping and recuperation of the solvent.

It is possible to carry out the process more than once in order to reach the desired thickness.

It is possible to repeat the process on one or more pieces to obtain different properties for the product obtained.

### Injection Method

To obtain a product that is the result of the union of a compatible substrate and a gel, the previously prepared gel, with properties that are suitable for the injection method, is inserted into an injection unit. After bringing the gel to the required injection temperature, and if required having heated the substrate in a closed mold, the injection pressure is adjusted according to the desired thickness of penetration of the gel into the substrate. The gel is then injected into the mold, into which the compatible substrate has previously been put.

By adjusting the injection speed, the injection pressure and the quantity injected, it is possible to obtain the desired thickness of penetration of the gel into the substrate.

It would be beneficial, either before or during said injection phases, that a certain degree of vacuum could be created inside the mold, which would facilitate the penetration and/or diffusion of the gel into the substrate.

Once the injection process is finished and any waiting time is concluded, the product is removed from the mold.

For the above-mentioned methods of application, immersion, hot coating, extrusion, and injection, of the method in the invention, one of the preferred compositions of said gel used is as follows:

SEBS, SBS, SIS, EVA, SEPS, SPBS polymer or their mixture with parts in weight between 5% and 39.5%.

Paraffinic or aromatic oil with parts by weight between 95% and 50%.

Viscosity modifiers compound with part comprised between 1.7% and 10% by weight.

Antioxidant with part comprised between 0.1 and 0.5 by weight.

Phase change material with part by weight up to 25%.

Colorants, as needed.

It is possible to increase productivity and the effectiveness of the penetration of said gel into the compatible substrate using mainly the above mentioned extrusion. With special compatible substrate-carrying vacuum masking, or the molten liquid itself in a vacuum, or eventually creating in the mold a certain degree of vacuum, it is possible to obtain greater penetration and/or in a shorter time of said gel into the compatible substrate.

It would be good to use as a gel, in at least one of the above-mentioned methods for carrying out said method that is the object of the invention, a thermosetting gel, mono or bi-component, and have it reticulate once absorbed.

The object of the invention is also the new product, realized according to the above mentioned extrusion method or, as an alternative, one of the other methods, characterized by the fact that it is made up of a substrate of a material compatible with the gel and that it has at least a part of its surface layer that has absorbed or is bonded with the gel.

Where the substrate of this product is at least one of those previously described.

Where the absorbed or diffused gel in at least one surface layer of said substrate is at least one of those previously described.

The drawbacks of the well-known technology and the purposes of this product are those described earlier.

The advantages of this product are at least one of those described earlier.

The methods for creating this product, by way of example only and in no way restrictive, are at least one of the methods set out earlier.

Advantageously, moreover, the final product obtained has a stable composition against stickiness and/or the final layer is a compatible polymer with a high degree of hardness (preferably greater than 5 ShA) and/or with a stable composition.

The final product obtained has physical properties that are an interaction between those of the compatible substrate and those of the gel used without any increase in dimension or thickness with respect to that of the compatible substrate used.

Lastly, this product can have various surface forms and/or a variance in the depositions and properties with deposition of gels with different characteristics, something that has not been possible in the past.

### Example 1

A gel article comprising wherein the porous substrate is a natural fabric or an elastomeric substrate, and the gel substrate comprising:

a polymer compound comprising:

from 14% to 17% by weight of Kraton G 1650 ES (low molecular weight linear triblock copolymer based on styrene and ethylene/butylene);

from 2% to 5% by weight of Kraton G 1654 ES (high molecular weight linear triblock copolymer based on styrene and ethylene/butylene);

from 50% to 58% by weight of Pureguard USP 68 (paraffinic white oil);

a viscosity modifiers compound comprising:

from 4% to 6% by weight of Microthene FN51000 (powder of low density ultrafine polyethylene);

from 0.3% to 0.7% by weight Finawax-E (slip agent);

from 0.8% to 1.2% by weight of LLP8555 (a linear low density polyethylene resin);

from 0.2% to 0.5% by weight of Songnox 11B (phenolic antioxidant);

from 15% to 20% by weight of EnFinit PCM 28 CPX (phase change material);

from 0.2% to 0.4% by weight of blue pigment.

### Example 2

A gel article comprising wherein the porous substrate is a natural fabric or an elastomeric substrate, and the gel substrate comprising:

a polymer compound comprising:

from 18% to 22% by weight of Kraton G 1650 ES (low molecular weight linear triblock copolymer based on styrene and ethylene/butylene);

from 3% to 6% by weight of Kraton G 1654 ES (high molecular weight linear triblock copolymer based on styrene and ethylene/butylene);

from 65% to 73% by weight of Pureguard USP 68 (paraffinic white oil);

a viscosity modifiers compound comprising:

from 4% to 6% by weight of Microthene FN51000 (powder of low density ultrafine polyethylene);

from 0.4% to 0.7% by weight Finawax-E (slip agent);

from 0.8% to 1.2% by weight of LLP8555 (a linear low density polyethylene resin);

from 0.4% to 0.5% by weight of Songnox 11B (phenolic antioxidant);

from 0.2% to 0.4% by weight of blue pigment

### Example 3

As discussed above, one of the assets of the material obtained by the diffusion of the gel in the substrate of the product is its non-stickiness and the fact that oils are not released.

This characteristic allows the product to be die-cut also after impregnation, without the material having any of the above-mentioned problems in the relative perforations.

In the event that the product has had holes put in previously, and it is therefore crucial to keep the holes free and not blocked by the material, a gel is used whose mix has a low viscosity and which spreads easily into the substrate of the material.

By using two products of the Kraton range, Kraton G1654 ES and the Kraton G 1650, the preferred mixtures and preferred gels were obtained. The various Kraton products can be mixed in any proportion to obtain the above-mentioned gels.

In particular, the Kraton G 1654 ES (high molecular weight) used in an amount between 5% and 20% provides excellent mechanical properties. The Kraton G 1650 (low molecular weight) in percentages between 5% and 30% gives the molten product a low viscosity and allows the rubber content to be increased until it completely eliminates oil leaks or almost completely limits it. Normally the two rubbers are used mixed. In this way it is possible to obtain a gel with optimal mechanical properties, low viscosity to favor absorption, and without oil leaks or just in negligible amounts.

### Detailed Example of a Specific Composition with a Specific Application Method

A preferential composition with excellent mechanical properties, the absence of oil leaks and optimal viscosity is the following: Kraton G 1654 ES 10%; Kraton G 1650 16-18%; white oil (100 cSt at 40° C.) 72-74%.

Using the coating and/or immersion method excellent absorption is obtained of the above-mentioned gel into the substrate. In particular with the immersion method the gel is always kept molten and therefore capable of being absorbed into the substrate (it cannot cool, unlike what would happen pouring the gel over the substrate). In fact, the viscosity of the molten product depends on the temperature and small variations in temperature would convert into huge variations in viscosity with the subsequent impossibility of absorption or of obtaining free holes.

With the coating method it is possible to intervene by varying the rate of the delivery of the product and its movement, so to achieve a situation that is similar, locally, to absorption. In fact, where the outlet is, where gel comes out in the head, the material is kept molten by the head itself and therefore absorption is possible.

Coating offers the possibility of being able to continually vary the size of the piece:

having a fixed span (width) of deposition dictated by the head; the length of the deposition is not a problem. It is even possible to coat the rolls. To foster absorption and to obtain free holes even if small ones (3 mm in diameter) it is possible to work with the head at a heavy tangent to the piece in order to exploit the sponge effect of the material once it regains it dimensions after being compressed (locally).

Moreover, the coating method allows the gel with a high rubber content (over 30%) to be absorbed better, which otherwise, with absorption, would have been very difficult and slow. Immersion, on the other hand, requires more masks or tanks for carrying out depositions of differing dimensions and lends itself to medium small runs and smallish pieces, 0.5-1 square meter at the most.

In practice the two techniques are complementary:

The absorption method: usually small pieces and high costs for producing a large number of big pieces;

The coating method: even very large pieces (the coating heads used can also be 6 meters long), high rates of production and more convenient absorption for large pieces (more than a square meter) and very long production runs.

The invention claimed is:

1. A product with gel, comprising:
a porous substrate; and
a gel substrate adjoined to the porous substrate, the gel substrate comprising a thermoplastic elastomer, a paraffinic aromatic oil, and a viscosity modifier compound;
wherein the viscosity modifier compound comprises:
a powder of low density ultrafine polyethylene;
a slip agent; and
a linear low density polyethylene resin.

2. The product as claimed in claim 1, wherein particles of the powder of low density ultrafine polyethylene are essentially spherical with an average size comprised between 10 micron and 50 micron.

3. The product as claimed in claim 1, wherein the powder of low density ultrafine polyethylene is comprised between 1% and 7% by weight.

4. The product as claimed in claim 1, wherein the slip agent comprises a refined vegetable oil mixed with erucamide.

5. The product as claimed in claim 4, wherein the slip agent is comprised between 0.2% and 1% by weight.

6. The product as claimed in claim 1, wherein the linear low density polyethylene resin comprises a hexane copolymer.

7. The product as claimed in claim 6, wherein the linear low density polyethylene resin is comprised between 0.5% and 2% by weight.

8. The product claimed in claim 1, wherein the gel substrate comprises an antioxidant.

9. The product as claimed in claim 8, wherein the antioxidant is a phenolic antioxidant.

10. The product as claimed in claim 9, wherein the antioxidant is comprised between 0.1% and 0.5% by weight.

11. The product as claimed in claim 1, wherein the gel substrate comprises a phase change material.

12. The product as claimed in claim 11, wherein the phase change material comprises particles containing paraffin with a melting point comprised between 24° C. and 32° C.

13. The product as claimed in claim 12, wherein the phase change material is comprised up to 25% by weight.

14. The product as claimed in claim 1, wherein the thermoplastic elastomer comprises one or more of SEBS, SBS, SIS, EVA, SEPS, SPBS, or a mixture thereof.

15. The product as claimed in claim 14, wherein the thermoplastic elastomer comprises predetermined amounts of high molecular weight polymers and low molecular weight polymers.

16. The product as claimed in 15, wherein a percentage of the high molecular weight polymers is comprised between 5% and 20% by weight, and a percentage of the low molecular weight polymers is comprised with between 5% and 30% by weight.

17. The product as claimed in claim 1, wherein the gel substrate comprises:
the thermoplastic elastomer in an amount by weight between 5% and 39.5%;
paraffinic or aromatic oil in an amount by weight between 50% and 95%;
the viscosity modifier compound in an amount by weight between 1.7% and 10%;
an antioxidant in an amount by weight between 0.1% and 0.5%; and
a phase change material in an amount by weight up to 25%.

18. The product according to claim 1, wherein the porous substrate is elastomeric and comprises a material adapted to promote at least a partial absorption of the gel substrate.

19. The product according to claim 18, wherein the elastomeric substrate is selected from the group consisting of a polyurethane foam, a viscoelastic polyurethane, a latex, or a fabrics.

20. A method of making a gel product according to claim 1, comprising:
providing a gel substrate comprising a thermoplastic elastomer, a paraffinic aromatic oil, and a viscosity modifier compound;
providing a porous substrate;
loading the gel substrate into an extruder equipped with a head adapted to cast a film of the gel substrate;
regulating temperature of extrusion;
adjusting viscosity of the gel substrate by varying a mixture of the thermoplastic elastomer and the amount of the viscosity modifier compound;
extruding the gel substrate onto the porous substrate to obtain an extruded article having the gel substrate overlapping the porous substrate;
if required, repeat the step of extruding to obtain an article with a required gel thickness; and
applying vacuum to the article to promote absorption of the gel by the porous substrate, the vacuum being applied at least during the step of extruding the gel substrate onto the porous substrate.
